(19) United States
(12) Patent Application Publication
(10) Pub. No.: US 2017/0071032 A1
(43) Pub. Date: Mar. 9, 2017

(54) SPACER FABRIC, SPACER FABRIC SECTION AND HEATABLE COVERING ELEMENT

(71) Applicant: MUELLER TEXTIL GMBH, WIEHL-DRABENDERHOEHE (DE)

(72) Inventors: Stefan Mueller, Wiehl (DE); Frank Mueller, Wiehl (DE)

(21) Appl. No.: 15/249,895

(22) Filed: Aug. 29, 2016

(30) Foreign Application Priority Data
Sep. 3, 2015 (DE) 10201514778.5

(51) Int. Cl. H05B 3/34

(52) U.S. Cl. CPC H05B 3/345; H05B 2203/013

(57) ABSTRACT

A spacer fabric has a first flat layer of knitted fabric formed with conductive threads, a second flat layer of knitted fabric and spacer threads connecting the first and second layers of knitted fabric. The conductive threads have an electrically conductive coating and are arranged adjacent to one another over an entire surface in the first layer or in conductive strips extending along a direction of production, and are connected to one another in direct, electrical contact. The conductive threads preferably are formed from a plastic multifilament yarn provided with a coating and have a fineness of less than 250 dtex. The conductive threads in the first layer of knitted fabric form loops with a stitching over at least two wales. The portion of the conductive coating is less than 50% by weight of the conductive threads.

### CROSS-REFERENCE TO A RELATED APPLICATION

The invention described and claimed hereinbelow is also described in German Patent DE 10 2015 12 114 778.5, filed on Sep. 3, 2015. This German Patent Application, subject matter of which is incorporated herein by reference, provides the basis for a claim of priority of invention under 35 U.S.C. 119(a)-(d).

### BACKGROUND OF THE INVENTION

The invention relates to a spacer fabric having a first flat layer of knitted fabric comprising conductive threads, a second flat layer of knitted fabric and spacer threads connecting the layers of knitted fabric; the conductive threads comprise an electrically conductive coating and are arranged adjacent to one another over an entire surface in the first layer of knitted fabric or in conductive strips extending along a direction of production, and are connected to one another in direct, electrical contact.

Various approaches are known for providing a spacer fabric with electrical conductors, in particular for heating purposes.

According to DE 199 03 070 A1, DE 10 2009 013 250 B3 and DE 42 39 068 A1, individual heating wires, which are not connected to one another and extend in the direction of production, are contacted to a transversely extending connecting lead. The contacting is relatively complex, wherein, in addition, the possibilities for using the described spacer fabric provided with heating wires are limited. If a heating wire becomes interrupted, heating cannot take place over the entire area of the corresponding width.

According to DE 103 42 285 A1, different possibilities for integrating heating conductors in a spacer fabric are disclosed. According to a first solution, conductive textile yarns are inserted between the two flat layers of knitted fabric in the region of the spacer threads. In this way, the corresponding heating conductors are protected to a certain extent, although the insulating effect of the spacer fabric, which is advantageous per se, is lost to a certain extent due to the centered arrangement of the heating conductors. Complex contacting also is required when the heating conductors are inserted into the pole region, i.e., between the spacer threads.

Alternatively, DE 103 42 285 A1 proposes to attach conductive yarns to at least one of the surfaces of the knitted fabric surfaces by embroidery techniques. This results in the disadvantage, however, that a further, complex method step is required, wherein yarns that have been incorporated by embroidery techniques can result in considerable irregularities in the spacer fabric.

A further alternative is proposed in DE 103 42 285 A1, according to which a purely two-dimensional woven fabric, knitted fabric, or crocheted fabric made from conductive, textile yarn is provided which is then laminated to the spacer fabric, for the purpose of which the two materials must be manufactured in separate method steps and wherein, in addition, a connection also must take place separately. In the case of the described textile materials in particular, bonding is frequently difficult due to the open textile structure, wherein the additional lamination adhesives can result in unpleasant odors during use and in increased effort with respect to disposal or recycling.

A textile material, which is formed by laminating at least two layers, is known from DE 202 20 752 U1. In this two-dimensional material, one of the layers is formed from conductive threads and from non-conductive threads. This textile material also is difficult to manufacture, without any cushioning effect.

Spacer fabrics of the type in question having conductive threads disposed in a first layer of knitted fabric are known from DE 10 2006 038 611 A1 and DE 10 2006 038 612 A1, wherein different variants for such a spacer fabric intended for heating purposes have been generally described. One of the layers of knitted fabric can consist entirely of conductive threads, in particular, of metal threads, wherein stranded wires are proposed therefor, because solid wires are difficult to process on a knitting machine and conventional wires can, at best, be inserted into the spacer fabric, but cannot be meshed.

Despite the considerable demand for easily handled, heatable spacer fabrics, the spacer fabrics described in DE 10 2006 038 611 A1 and DE 10 2008 038 612 A1 have not become established in practice. This is due, in particular, to the fact that suitable material could not be manufactured in a satisfying level of quality with a justifiable amount of effort.

A conductive polymer strip or polymer fabric, which can be used as a heating element, is known from DE 10 2009 003 867 A1. Within the scope of different possible designs, it is proposed that non-conductive polymer threads be provided with a conductive coating.

### SUMMARY OF THE INVENTION

The present invention overcomes the shortcomings of known arts, such as those mentioned above.

To that end, the invention provides a spacer fabric that can be easily manufactured and that has good functional properties. In addition, a spacer fabric section made therefrom, and a heatable covering element having such a spacer fabric section also are provided.

In an embodiment, the spacer fabric according to the invention includes that the conductive threads are formed from a plastic-multifilament yarn provided with a coating, have a fineness of less than 250 dtex and are knitted in the first layer of knitted fabric with a stitching over at least two wales. “dtex,” as used herein, is intended to mean the mass in grams per 10,000 meters. Preferably, the conductive threads also form loops, wherein the portion of conductive coating on the conductive threads is less than 50% by weight, preferably 15% by weight, and particularly preferably less than 5% by weight. The individual filaments of the multifilament core are not electrically conductive and therefore do not form a conductive core. The individual filaments are each enclosed in the coating and remain movable with respect to one another. The conductive threads then resemble, externally, at least in the case of a metallic coating, stranded wires, but they have entirely different properties due to the core-casing structure.

In an embodiment, the conductive threads extend across at least two wales during stitching and, therefore, adjacent wales are conductively connected, wherein a conductive surface is created in the corresponding layer of knitted fabric in the case of the entire spacer fabric. While the conductive threads preferably also form loops, limiting the conductive threads to be formed as loops is not absolutely necessary. For example, it also can be provided that the conductive threads are knitted over at least two wales, as an inlay, and thus extend in a zigzag without forming loops. As a further thread system, threads also can be provided in the first layer of knitted fabric, which extend only along one wale, according to a fringe stitch. The threads of this further thread system can be designed both non-conductive and conductive.

Even when a relatively great portion of up to 50% by weight is provided in the case of a metallic coating, the layer thicknesses on the individual filaments remain relatively small due to the higher density of the coating. Considering a typical geometry and the density of metallic coatings, the coating thickness always is less than 15% of the radius of the core, and preferably less than 5% of the radius of the core. Due to the core, which is in the form of the individual filaments, the electrically conductive threads retain a very high level of movability and deformability.

According to the prior art, conventional stranded wires or monofilament yarns provided with a metallic coating are relatively stiff and are therefore difficult to process. To overcome this shortcoming, the invention provides a relatively thin material having less than 250 dtex is provided according to the invention for the conductive threads, wherein, in addition, the electrically conductive coating, which results in stiffening, is relatively thin and amounts to less than 50% by weight relative to the core of the plastic filaments.

The plastic multifilament yarn is initially distinguished by greater movability than a monofilament yarn manufactured using the same material. Surprisingly, loops can be easily formed within the scope of the invention, wherein the conductive coating also remains undamaged, despite the great movability of the plastic multifilament yarn as the core and the extreme angling of the conductive threads during the manufacture of individual loops. The conductive coating usually is present on the individual filaments as a circumferentially closed casing, and therefore sufficient resistance on the part of the coating is ensured, despite extreme bending, due to this closed shape of the casing. The conductive coating can deform to a certain extent without bursting open or bursting off of the plastic multifilament yarn.

Within the scope of the invention, the electrically conductive coating can be designed in different ways.

According to a first variant, this electrically conductive coating is a metallic coating, wherein metals or metal alloys having good corrosion resistance and a certain level of deformability are options in particular. In addition, the costs for the conductive threads having the metallic coating must be taken into account. For example, the conductive threads can have a metallic coating on the basis of silver, which is easily deformed and has relatively good resistance. Specifically, in the case of a relatively low percentage by weight of the metallic coating, economical use is still possible in many types of application, despite the relatively high costs. One disadvantage, however, is that silver also forms a thin oxide layer on the surface, which, depending on the specific application, can result in uneven contacting or an uneven current flow, to a certain extent.

Copper also is an option, for example, as a more economical alternative to silver, wherein in this case as well a surface oxidation having the described disadvantages cannot be ruled out under all circumstances. In addition, gold can be provided as a metallic coating in order to avoid the described disadvantages, although the costs are then substantially higher.

According to another embodiment, a non-metallic coating is provided. In particular, graphite or another carbon-based material is an option, wherein the formation of an undesirable oxide layer can then be avoided, as a rule. Graphite is distinguished by relatively good movability. In principle, however, other non-metallic coatings also are options, according to the invention, wherein these can be formed, in principle, as a type of conductive, polymer-based varnish or the like.

Finally, a multilayer coating also is possible, according to the invention. For example, different metallic or non-metallic layers can be combined with one another, in order to achieve an adaptation that has been optimized for the particular application with regard to the conductivity, on the one hand, and with regard to the electrical contacting on the surface, on the other hand. For example, a multilayer coating comprising an inner layer made from copper or silver, on which a thin cover layer made from gold is vapor-deposited is within the scope and spirit of the invention.

An embodiment of the conductive threads made from the plastic multifilament yarn provided with the coating is relevant not only directly in the knitting process, but also in a subsequent finishing process. In a finishing process, temperature is applied, in which case the textile material is heated to the extent that, although the individual threads and filaments do not melt, tensions in the threads resulting from their angling in the loops of the spacer fabric can be reduced by way of the viscous flowing of the polymer chains. While plastic threads initially strive to return to their straight starting shape due to the inner tensions, these tensions are eliminated by the finishing, wherein the angled state in the knitted fabric is then “frozen”, to a certain extent, after finishing as a result of cooling down.

In an embodiment, the individual filaments of the plastic multifilament yarn, which are preferably provided with the coating individually, also are movable with respect to one another to a certain extent, whereby the improved processability during manufacture and during finishing is achieved. Specifically in the case of a metallic coating, advantages can result in the finishing process, because the heat is easily conducted through the coating to the filaments.

Although the first flat layer of knitted fabric contains conductive threads, the spacer fabric is still relatively soft and has a pleasant feel. In an embodiment of the invention, known knitting patterns of non-conductive spacer fabrics can be largely relied upon, wherein the first flat layer of knitted fabric is then formed, in part or entirely, from conductive threads.

As explained above, silver is preferably provided as a metallic coating, wherein relatively high material costs for the metallic coating must then be accepted. Silver is distinguished by good conductivity, a low tendency to corrode and good deformability. Due to these properties, the metallic coating such as that provided by silver can be designed very thin, depending on the application, wherein the mechanical properties of the conductive threads are then influenced by the metallic coating only to a small extent. A stiffening resulting from the metallic coating can then be kept very low overall. For example, a silver metallic coating has a thickness that is less than 5%, and preferably less that 0.5% of the radius of the core.

According to the invention, a weight fraction of the electrically conductive, in particular, metallic coating, as compared to the total weight of the conductive threads is preferably less than 15% by weight, for example, 5% by weight in one embodiment, or 1% by weight in another embodiment.

According to the invention, the conductive threads have a fineness of less than 250 dtex, wherein the fineness is preferably between 90 and 200 dtex. For example, conductive threads having a fineness of 110 dtex or a fineness of 145 dtex can be used, without deviating from the scope and spirit of the invention.

The number of individual filaments is preferably between 3 and 40, in order to ensure sufficient movability, on the one hand, and to ensure low manufacturing costs and good mechanical properties. For example, the number of filaments can be between 12 and 30, for example 24, or some other number between 3 and 40, without deviating from the scope and spirit of the invention.

The second fabric layer is preferably formed from multifilament yarn having a fineness between 50 dtex and 340 dtex. Polyamide, including polyamide copolymers such as PA6, polyester, in particular, polyethylene terephthalate (PET), and polypropylene can be utilized both for the second layer of knitted fabric and for the filaments of the conductive threads.

Different possible designs for the further embodiment of the first layer of knitted fabric may be utilized in the invention, wherein, however, each conducting thread is usually connected to at least one further conducting thread in direct electrical contact. The electrical contact is achieved as a result of the knitting pattern. In the simplest case, for example, adjacent conductive threads are connected to one another using a tricot stitch, wherein any other types of stitches also may be utilized in which the conductive threads are guided over at least two wales and thus intersect in sections.

It is within the scope of the invention that the conductive threads are disposed over the entire area in the first layer of knitted fabric. If the conductive threads are then provided as a single thread system, the first layer of knitted fabric is formed exclusively from the conductive threads. It also is possible, however, that the first layer of knitted fabric is formed from the conductive threads as a first thread system and a second thread system of non-conductive threads, for the purpose of which two or more guide bars are therefore used for forming the first flat layer of knitted fabric.

In addition, an embodiment is provided in which the first layer of knitted fabric comprises conductive strips extending along the direction of production, wherein the conductive threads are then present only in these conductive strips. Within the scope of such an embodiment, groups of conductive threads can alternate with groups of non-conductive threads transversely to the direction of production, wherein preferably at least ten conductive threads are provided for forming each strip extending in the direction of production. In the case of such a material, however, it should be noted that all conductive strips must be contacted in a suitable manner, because a continuously conductive area is not formed.

Since the conductive threads are not only inserted in the first layer of knitted fabric, but rather also are meshed, these threads also are intimately connected to one another, and therefore good direct electrical contact is ensured simply due to the conductive threads touching one another.

In an embodiment, the spacer threads are usually formed from monofilament yarn, in order to ensure the necessary resistance to crushing and elasticity of the spacer fabric. The filament diameter can be, for example, between 30 μm and 100 μm, in particular between 55 μm and 80 μm, or any other diameter or diameter range, without deviating from the scope and spirit of the invention. Since the monofilaments are incorporated into the two layers of knitted fabric during the manufacture of the spacer fabric, the spacer threads also result in a stiffening of the two fabric layers, to a certain extent. Against this background, it is advantageous that, according to the invention, the first flat layer of knitted fabric does not undergo any further strong stiffening, due to the use of the conductive threads having a great fineness and a core made from plastic multifilament yarn in a relatively thin coating.

The invention also provides a spacer fabric section formed from the previously described spacer fabric, which, in the simplest case, is punched or cut from a material web of the spacer fabric.

In an embodiment, the spacer fabric section has at least one opening, at which both layers of knitted fabric and the interposed spacer threads have been removed, whereby the conductive threads in the first layer of knitted fabric also are therefore interrupted. Corresponding openings can be formed by punching or cutting, for example.

Depending on the intended use of the spacer fabric section, the openings can be initially necessary due solely to design requirements. When the spacer fabric is used, for example, as part of a covering element for a motor vehicle, openings can be necessary on the side of the door, a roof lining, or the like, so that operating elements of the motor vehicle can be guided through the spacer fabric section. When the spacer fabric section is used on a side of a door, it is frequently necessary, for example, to provide a cut-out for a handle or an actuating element of the lock. The same applies, for example, in the arrangement in a roof lining, when the inner covering is intended to be interrupted there for a light, a display element, or the like.

An advantage results, within the scope of the invention, that regions that are conductive over a large surface area are provided due to the flat arrangement of the conductive threads in strips or in the entire first layer of knitted fabric and by the direct electrical contact of adjacent conductive threads. When such a spacer fabric section is then provided with openings, the application of a current can result in a current flow around the openings, and therefore, particularly flexible possible uses result.

A further advantage that results is that complex contacting can be dispensed with in some applications, within the scope of the invention. A contacting can take place, for example, using simple clamps, conductive adhesive, or the like, wherein only one point connection is provided, from which an even current distribution is then possible due to the properties of conducting in two dimensions. Alternatively, however, a linear connection also can take place, in order to ensure a particularly reliable and even contacting. In the case of a metallic coating, a contacting also can take place by soldering or welding. If necessary, the application of heat necessary therefor also can be achieved directly by applying current to the arrangement. For example, a low melting point contact lead or a contact lead provided with a low melting point casing could be applied thereon, wherein a fusion then takes place directly by the application of a higher (as compared to the previous operation) current.

Preferably, spaced-apart electrical contacts are provided, which are directly connected to the conductive threads extending on the contact surface via punctiform or linear contact areas. The punctiform or linear contact areas each preferably extend over less than 5%, in particular less than 2% of the total area of the entire spacer fabric section.

When the spacer fabric section is provided with openings and spaced-apart electrical contacts, multiple openings also can be provided, in particular, which are arranged in such a way that, when current is applied to the electrical contacts, a more even two-dimensional current distribution results than would be the case with a spacer fabric section having no openings but an otherwise identical design. In this case, it should be noted, however, that the current must be guided around the openings, whereby a greater current density and greater heating can result locally there. If the openings are too large and, therefore, segments remaining at the sides of the openings are too small, there can be a danger of overheating or burning-through. When the aspects of the design that are essential for the conduction of the current are taken into account, however, an optimization of the current flow and, therefore, the heating can be achieved using openings, incisions, or the like, depending on the application. This aspect is explained in greater detail in the following.

That is, where the greatest current flow results at a direct connection between the two contacts in the case of an uninterrupted space fabric section extending across the entire surface, the current flow can be further manipulated and optimized by use of openings.

For that matter, instead of openings, it also may be sufficient when only individual separating regions are created in the first layer of knitted fabric provided with the conductive threads, wherein non-conductive barriers are then created by separating cuts or the like, in order to positively influence the current flow overall. When only the first fabric layer is cut into, in sections, the mechanical properties of the spacer fabric remain largely unchanged there.

Utilizing the described measures, it is possible to locally change and adapt the temperature development at the spacer fabric section in accordance with the particular requirements. For this purpose, the invention subsequently provides regions of the first flat layer of knitted fabric with an additional conductive coating, in order to reduce the resistance there and, therefore, the local heat development, when the spacer fabric is used for heating purposes.

In an embodiment, the invention also provides a heatable covering element comprising the above-described spacer fabric section and a cover layer disposed on the spacer fabric section. The cover layer is preferably disposed on the first layer of knitted fabric provided with the conductive threads, and therefore an advantageous insulating effect also is ensured by the spacer threads and the second layer of knitted fabric. Due to the properties of the spacer fabric, the side of the heatable covering element provided with the cover layer is efficiently heated, while, as a rule, undesirable thermal losses on the opposite side are avoided.

The heatable covering element can be provided, for example, in the automotive sector for covering the side of a door, a center console, an arm rest, the footwell, the roof lining, the dashboard, or the steering wheel. The heatable covering element also can be a component of a seat heater in a motor vehicle. The spacer fabric section can be provided with a cover layer made from leather, artificial leather, film, a further textile, or the like.

The heatable covering element also can be used in the technical field of construction and architecture, in order to form heatable soundproof panels, room dividers, wall surfaces, blankets, or floor heaters.

In the medical field, a spacer fabric section according to the invention can be used with or without a further cover layer for deckchairs, heated blankets, armchairs, or stools. It is also possible to form heatable bandages.

Further intended uses of the invention also are conceivable, such as, for example, the use in heatable clothing, heatable inlay soles, or heatable gloves, which are suitable, in particular, for low-temperature applications.

Further possible uses include heated liners in strollers, heated mattress covers, and outdoor use to prevent freezing, or as support or protection for vegetation.

When silver is used as the conductive coating, the antibacterial effect of silver also can be a further advantage in some of the aforementioned applications.

In the bulk of the described applications, different advantageous aspects of the spacer fabric according to the invention or of the spacer fabric section according to the invention are utilized, the spacer fabric being distinguished by high elasticity and adaptability, good heating properties, an application-oriented, variable shape (due to the formation of openings and the cutting to fit), optimal drapeability and manufacture that is simple as compared to known embodiments.

### BRIEF DESCRIPTION OF THE DRAWING FIGURES

The invention is explained in greater detail in the following with reference to a drawing. In the drawings:

FIG. 1 shows the design of the spacer fabric;

FIG. 2 shows one alternative embodiment of the spacer fabric according to FIG. 1;

FIG. 3 shows a section through a conductive thread of a first layer of knitted fabric of the spacer fabric, according to the inventive embodiments of FIG. 1 and FIG. 2;

FIG. 4 shows a strip-shaped spacer fabric section having an opening;

FIG. 5 shows a spacer fabric section having multiple openings and spaced-apart electrical contacts;

FIG. 6 shows an alternative embodiment of the spacer fabric section according to FIG. 5; and

FIG. 7 shows a variation of the spacer fabric section of FIG. 6.

### DETAILED DESCRIPTION OF THE PREFERRED EMBODIMENTS

The following is a detailed description of example embodiments of the invention depicted in the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

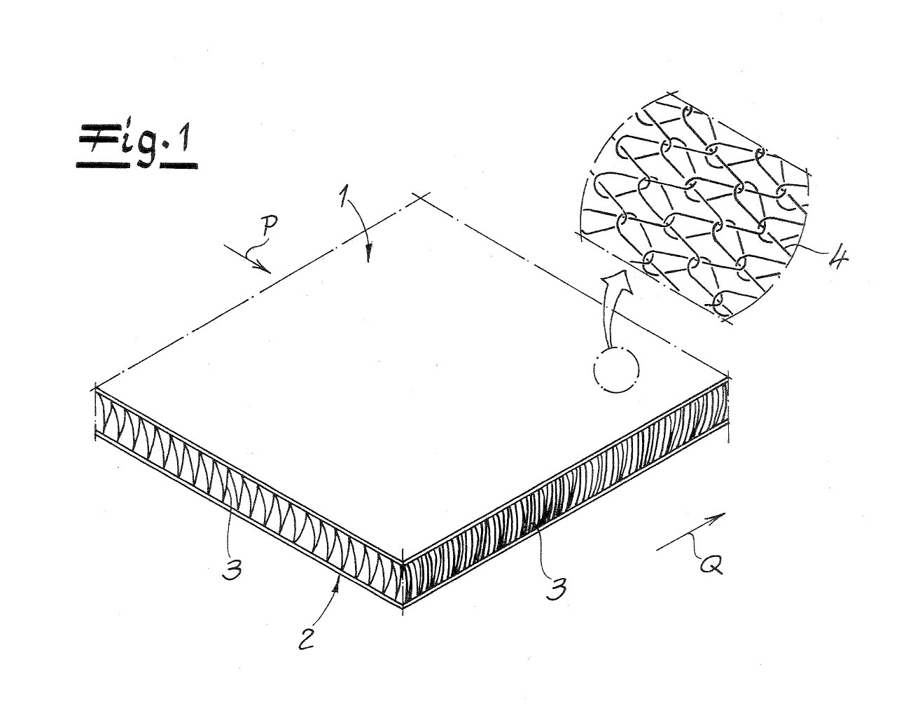

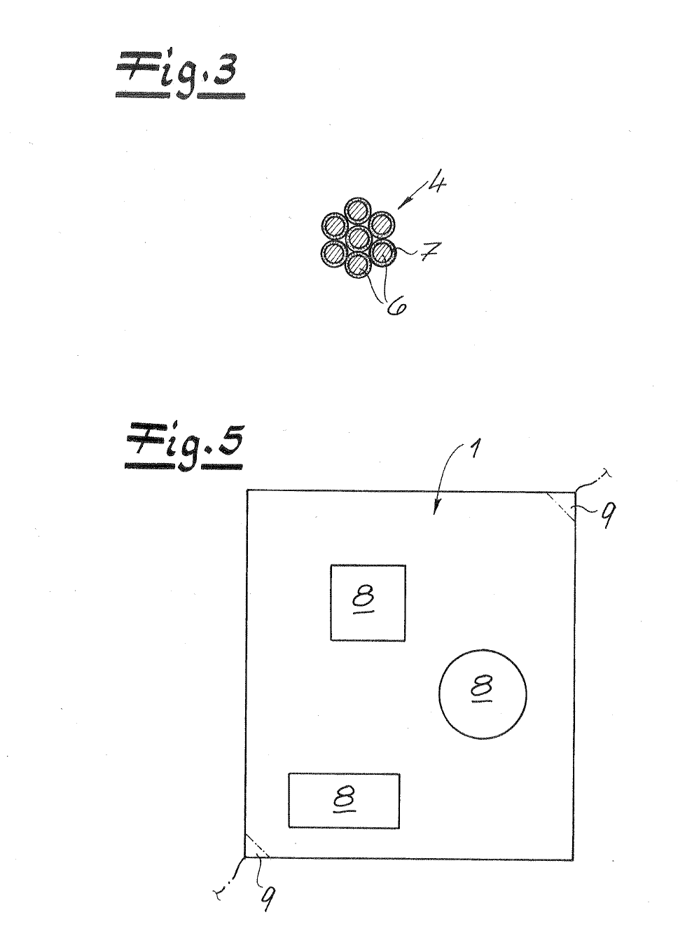

FIG. 1 shows the basic design of a spacer fabric according to the invention, comprising a first flat layer of knitted fabric 1, a second flat layer of knitted fabric 2, and spacer threads 3 connecting the layers of knitted fabric 1, 2. The first layer of knitted fabric 1 comprises conductive threads 4, which are further described in the following in association with FIG. 3.

According to FIG. 1, the entire first layer of knitted fabric 1 is formed from conductive threads 4, wherein, according to the detailed sectional view from FIG. 1, the electrically conductive threads 4 are arranged in a tricot stitch, and therefore the conductive threads 4 in the first layer of knitted fabric 1 form loops over two wales. Due to the formation of loops, adjacent conductive threads 4 are closely intertwined and are electrically connected to one another by means of a direct electrical contact on the surface of the conductive threads 4.

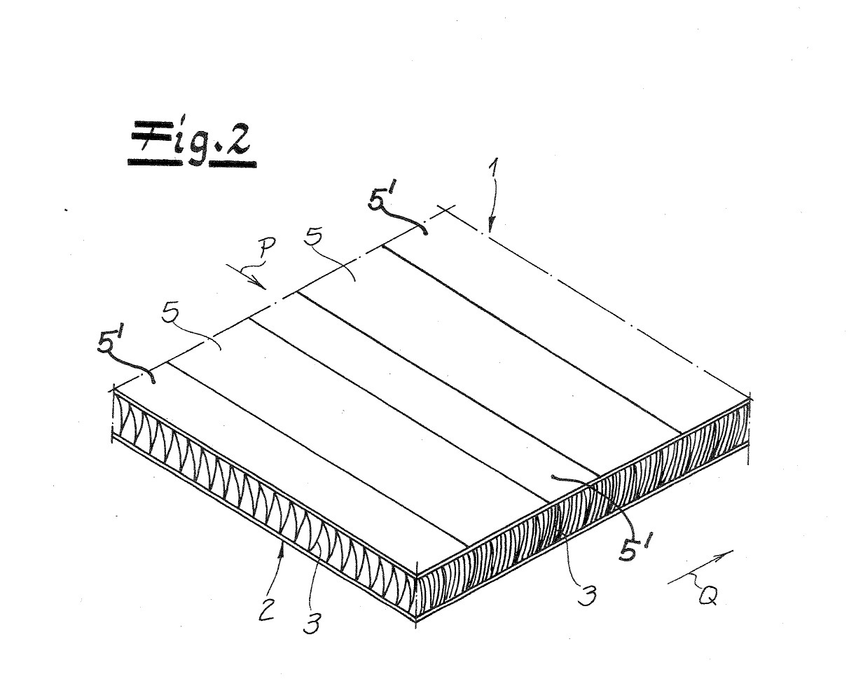

The spacer fabrics according to FIG. 1 and FIG. 2 differ in that, according to FIG. 2, the conductive threads 4 are disposed only in conductive strips 5, and not in the strips 5′ that are shown separating the conductive strips 5. Different threads may be used in the strips 5′, wherein the stitching pattern nevertheless remains the same as in the conductive strips 5. Preferably, at least ten threads extending in a direction of production P are provided for forming the conductive strips 5. Groups of conductive threads 4 therefore alternate with groups of non-conductive thread in the transverse direction Q.

FIG. 3 shows a detailed view of a cross-section of the conductive threads 4 provided within the scope of the invention. Accordingly, the conductive threads 4 comprise a plastic multifilament yarn 6 provided with a coating 7, wherein the plastic multifilament yarn usually comprises between 3 and 40 filaments, for example, 24 filaments, or any other number of filaments between 3 and 40, without deviating from the scope and spirit of the invention. The portion of the conductive coating 7 relative to the total weight of the conductive threads is less than 50% by weight, in particular. less than 15% by weight, for example, between 1% by weight and 5% by weight. The conductive coating 7 can be either metallic or non-metallic. Reference is made in the following to a metallic coating 7 in the form of silver, as a preferred embodiment, merely by way of example.

Due to the core-casing structure of the plastic multifilament yarn 6 provided with the coating 7, the conductive threads 4 are moveable to a particular extent, wherein the metallic coating 7 made from silver is distinguished by a low electrical resistance, and therefore the metallic coating 7 is relatively thin, i.e., in view of a typical geometry and the density of metallic coatings, the coating thickness always is less than 15% of the radius of the core, and preferably less than 5% of the radius of the core. Surprisingly, the metallic coating 7 is not destroyed during the formation of loops of the filaments, which is precisely why the relatively soft properties of silver are advantageous. The thin metallic coating 7 also makes it possible to stiffen the filaments of the plastic multifilament yarn 6 only to a slight extent.

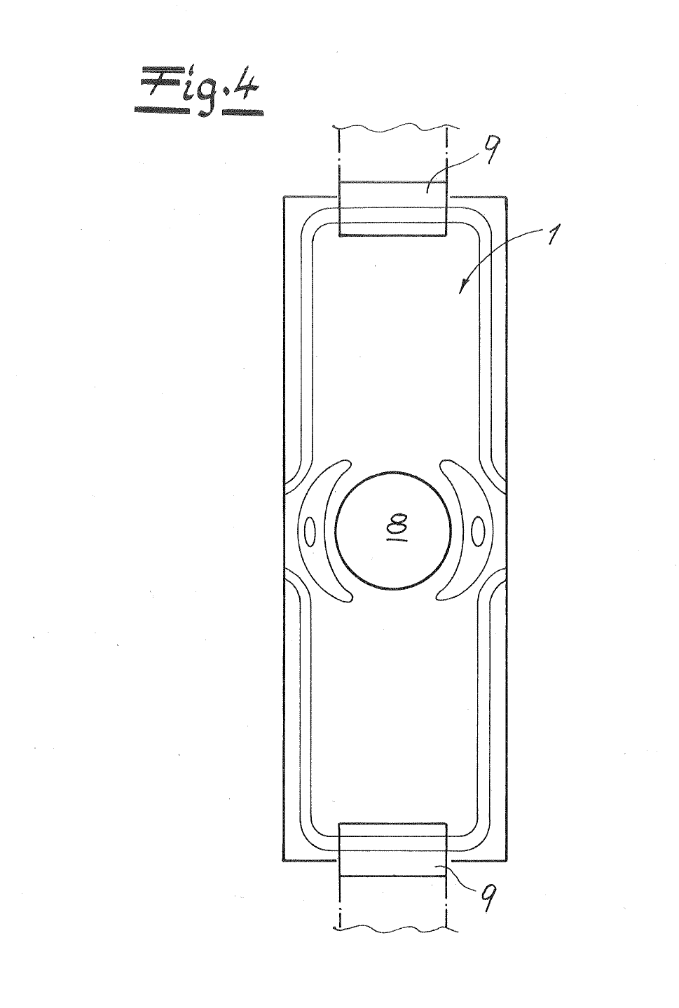

FIG. 4 shows a spacer fabric section, which is provided with an opening 8 for test purposes. The spacer fabric section can be formed from a spacer fabric according to FIG. 1, wherein a similar behavior results, however, when a conductive strip 5 having an opening 8 is provided in a spacer fabric according to FIG. 2.

In FIG. 4, the spacer fabric section is provided, at its ends with electrical contacts 9 in the form of simple connection terminals. Since the spacer fabric on the first layer of knitted fabric 1 is two-dimensionally conductive, a contacting via connecting leads or the like can be dispensed with, depending on the application. A linear contacting also can be advantageous in terms of an even, reliable current distribution.

Lines corresponding to a certain temperature are shown in FIG. 4 for illustrating the heating. The temperature profile is therefore depicted in the manner of an elevation map or a topographical map.

Initially, it is apparent that the temperature decreases toward the edges of the spacer fabric section due to the increased cooling as a result of heat dissipation to the surroundings and due to the reduced current flow. In addition, a largely even temperature profile results over a large portion of the spacer fabric section, however.

At the opening 8, the conductive threads 4 have been interrupted, and therefore, the current flow must take place around the opening 8. Consequently, a greater current and, therefore, increased heat output result there. According to the invention, however, due to the two-dimensionally conductive properties of the spacer fabric, openings 8 can be formed in the material provided the openings 8 are not too large and the segments remaining on the sides of the openings 8 have sufficient conductivity. The openings 8 can be provided, for example, for purely practical reasons, in order to provide passage openings or to guide mechanical connecting elements therethrough. Suitable openings 8 can be necessary or expedient, for example, in order to use the spacer fabric section as a heatable covering element having a cover layer.

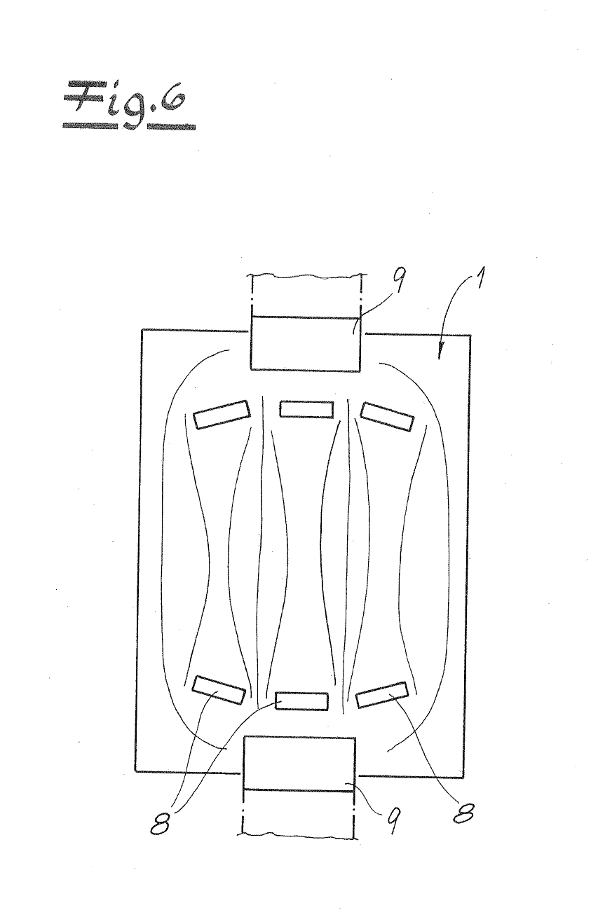

FIG. 5 shows that virtually any type of opening 8 can be provided in a spacer fabric section, wherein such a spacer fabric section is expediently provided with electrical contacts 9 on opposite ends. In addition to connection terminals, electrical contacts also can be easily bonded onto the first layer of knitted fabric 1, in order to contact the conductive threads 4 extending there, at a point.

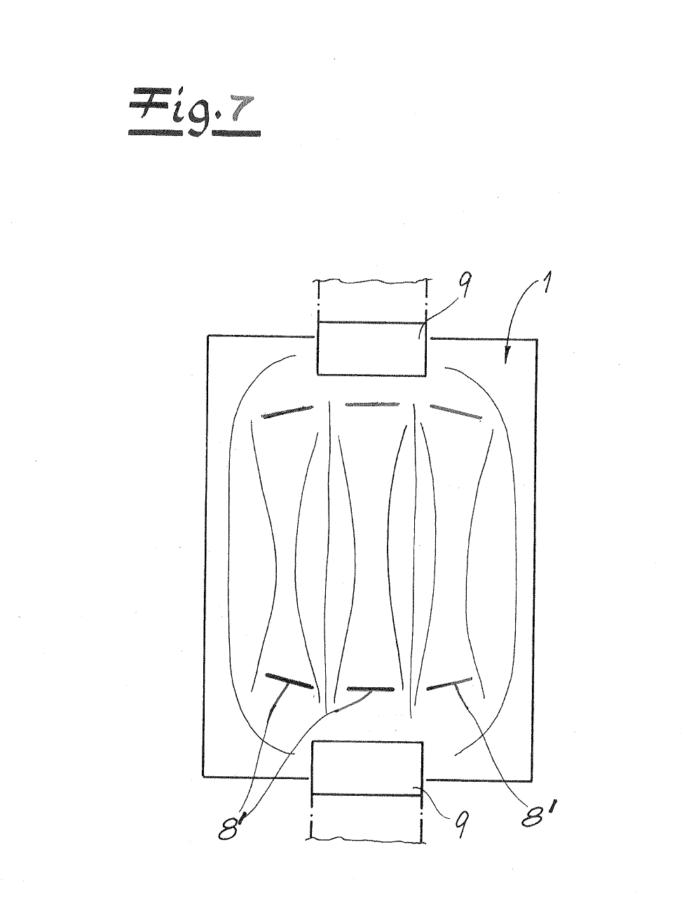

FIG. 6 shows that, due to the position of the openings 8, the current distribution and, therefore, the heating of the spacer fabric section can be influenced and adapted to the particular requirements. For this purpose, instead of continuous openings 8, it is also possible to simply provide incisions 8′ in the first layer of knitted fabric 1, which separate the conductive threads 4 in sections. The FIG. 7 embodiment depicts the incisions 8′ rather than the continuous openings 8, depicted in FIG. 6. Due to the described measures, a very even heating can take place, depending on the requirements, or individual regions can be heated to a great extent, to a lesser extent, or not at all, depending on the requirements.

Provided the conductive threads 4 are not interrupted, the thermal conduction within the material also contributes to an even thermal distribution, wherein silver, specifically, as a preferred metallic coating 7, has particularly good thermal conductivity.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A spacer fabric, comprising:
a first flat layer of knitted fabric formed with conductive threads;
a second flat layer of knitted fabric; and
spacer threads connecting the first layer and the second layer of knitted fabric;
wherein the conductive threads comprise an electrically conductive coating, are arranged adjacent to one another over an entire surface in the first layer of knitted fabric or are arranged in conductive strips extending along a direction of production (P) of the first layer of the knitted fabric and are connected to one another in direct, electrical contact;
wherein the conductive threads are formed from a plastic multifilament yarn provided with the conductive coating, have a fineness of less than 250 dtex and are knitted in the first layer of knitted fabric with a stitching over at least two wales;
wherein the conductive coating comprises a portion of the conductive threads that is less than 50% by weight; and
wherein individual filaments of the plastic multifilament yarn are each enclosed in the conductive coating and are movable with respect to one another.

2. The spacer fabric according to claim 1, wherein the conductive coating consists of metal.

3. The spacer fabric according to claim 1, wherein the metal comprises silver.

4. The spacer fabric according to claim 1, wherein the filaments of the plastic multifilament yarn consist of a material selected from the group consisting of polyamide, polyester and polypropylene.

5. The spacer fabric according to claim 1, wherein at least ten conductive threads are provided for forming the conductive strips extending in the direction of production (P).

6. The spacer fabric according to claim 1, wherein the conductive threads are disposed over the entire surface in the first layer of knitted fabric; and wherein the first layer of knitted fabric is formed exclusively of the conductive threads.

7. The spacer fabric according to claim 1, wherein the spacer threads are formed from a monofilament yarn having a filament diameter between 55 μm and 80 μm.

8. A spacer fabric section formed from a spacer fabric according to claim 1.

9. The spacer fabric section according to claim 8, wherein both the first layer and the second layer of knitted fabric and the interposed spacer threads have been removed at at least one opening in the spacer fabric section, and wherein the conductive threads in the first layer of knitted fabric have therefore been interrupted in said at least one opening.

10. The spacer fabric section according to claim 7, wherein spaced-apart electrical contacts are directly connected to the conductive threads of the first layer of knitted fabric extending on the contact surface, via punctiform contact areas.

11. The spacer fabric section according to claim 10, wherein multiple openings are provided and are disposed in such a way that, when current is applied to the electrical contacts, a more even two-dimensional current distribution results than would be the case with a spacer fabric section having no openings but an otherwise identical design.

11. A heatable covering element comprising a spacer fabric section according to claim 8 and a cover layer disposed on the spacer fabric section.
